(19) United States
(12) Patent Application Publication
(10) Pub. No.: US 2025/0265097 A1
(43) Pub. Date: Aug. 21, 2025

(54) ONBOARD APPARATUS, ONBOARD SYSTEM, METHOD, AND STORAGE MEDIUM STORING PROGRAM

(71) Applicant: DENSO CORPORATION, Kariya-city (JP)

(72) Inventor: Masatake Wada, Kariya-city (JP)

(21) Appl. No.: 19/199,537

(22) Filed: May 6, 2025

Related U.S. Application Data
(63) Continuation of application No. PCT/JP2023/045117, filed on Dec. 15, 2023.

(30) Foreign Application Priority Data
Dec. 28, 2022 (JP) 2022-212068

(51) Int. Cl. G06F 9/4401; B60W 30/188; G06F 8/61

(52) U.S. Cl. CPC G06F 9/4418; B60W 30/1886; G06F 8/61

(57) ABSTRACT

An onboard apparatus mounted on a vehicle is configured to connect a plurality of onboard devices mounted on the vehicle, manage an apparatus power state of the onboard apparatus, install a plurality of applications and execute the applications installed, and manage a device power state of the onboard devices connected to the device connection unit. An on state is defined as a state in which power is supplied. The device power management unit, based on device usage information in a manifest in which the device usage information indicating the onboard device used by an installed application is set, sets an onboard device necessary for the installed and operating application to execute processing to a device on state, which is the on state of the onboard device.

### CROSS REFERENCE TO RELATED APPLICATIONS

The present application is a continuation application of International Patent Application No. PCT/JP2023/045117 filed on Dec. 15, 2023 which designated the U.S. and claims the benefit of priority from Japanese Patent Application No. 2022-212068 filed on Dec. 28, 2022. The entire disclosures of all of the above applications are incorporated herein by reference.

### TECHNICAL FIELD

The present disclosure relates to an onboard apparatus mounted on a vehicle.

### BACKGROUND

A related art describes a vehicle control apparatus equipped with a main microcontroller and a sub-microcontroller, to which multiple displays are connected. The sub-microcontroller is described as activating the main microcontroller upon detecting a start trigger.

### SUMMARY

According to an aspect of the present disclosure, an onboard apparatus mounted on a vehicle is configured to connect a plurality of onboard devices mounted on the vehicle, manage an apparatus power state of the onboard apparatus, install a plurality of applications and execute the applications installed, and manage a device power state of the onboard devices connected to the device connection unit. An on state is defined as a state in which power is supplied. The device power management unit, based on device usage information in a manifest in which the device usage information indicating the onboard device used by an installed application is set, sets an onboard device necessary for the installed and operating application to execute processing to a device on state, which is the on state of the onboard device.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of a mobility IoT system;

FIG. 2 is a block diagram showing the configuration of an edge device;

FIG. 3 is a functional block diagram showing the functional configuration of the edge device;

FIG. 4 is a diagram showing the transition of the power state of the edge device;

FIG. 5 is a flowchart showing the IG (ignition) on start processing;

FIG. 6 is a flowchart showing the IG off start processing;

FIG. 7 is a flowchart showing the voltage monitoring processing;

FIG. 8 is a flowchart showing the wake-up factor monitoring processing of the first embodiment; and

FIG. 9 is a flowchart showing the wake-up factor monitoring processing of the second embodiment.

### DETAILED DESCRIPTION

As a result of detailed studies by the inventor, it has been found that there is a need to reduce the power consumption of onboard devices in an onboard apparatus configured to connect multiple onboard devices mounted on a vehicle. Similarly, in an onboard system including multiple onboard devices, there is a need to reduce the power consumption of the onboard devices.

The present disclosure provides a technique to reduce the power consumption of onboard devices.

One aspect of the present disclosure is an onboard apparatus mounted on a vehicle, including a device connection unit, an apparatus state management unit, an application execution unit, and a device power management unit.

The device connection unit is configured to connect a plurality of onboard devices mounted on the vehicle.

The apparatus state management unit is configured to manage the apparatus power state of the onboard apparatus.

The application execution unit is configured to install and execute a plurality of applications.

The device power management unit is configured to manage the device power state of the onboard devices connected to the device connection unit.

The state in which power is supplied is defined as the on state. Based on the device usage information set in the manifest, which indicates the onboard devices used by the installed applications, the device power management unit sets the onboard devices necessary for the installed and operating applications to execute processing to the device on state.

The onboard apparatus of the present disclosure, configured as described above, sets the onboard devices necessary for the installed and operating applications to execute processing to the device on state based on the device usage information in the manifest. Therefore, even when onboard devices are retrofitted to the onboard apparatus, the onboard apparatus of the present disclosure can prevent the unnecessary activation of onboard devices that are not used by the operating applications. This allows the onboard apparatus of the present disclosure to reduce the power consumption of the onboard devices.

Another aspect of the present disclosure is an onboard system including a plurality of onboard devices, an application execution unit, and a device power management unit. The device power management unit sets the onboard devices necessary for the installed and operating applications to execute processing to the device on state based on the device usage information in the manifest, which indicates the onboard devices used by the installed applications.

The onboard system of the present disclosure can achieve the same effects as the onboard apparatus of the present disclosure.

Yet another aspect of the present disclosure is a method executed by an onboard system including a plurality of onboard devices and an onboard apparatus. The onboard apparatus is configured to install and execute a plurality of applications. In the method, managing the device power state of the onboard devices includes setting the onboard devices necessary for the installed and operating applications to execute processing to the device on state based on the device usage information in the manifest, which indicates the onboard devices used by the installed applications.

The method of the present disclosure is executed by the onboard apparatus of the present disclosure, and by executing this method, the same effects as the onboard apparatus of the present disclosure can be obtained.

Another aspect of the present disclosure is a program for execution by an onboard apparatus configured to connect a plurality of onboard devices mounted on a vehicle, install a plurality of applications, and execute the installed applications. The program includes processing to manage the device power state of the onboard devices. Managing the device power state of the onboard devices includes setting the onboard devices necessary for the installed and operating applications to execute processing to the device on state based on the device usage information in the manifest, which indicates the onboard devices used by the installed applications.

A computer controlled by the program of the present disclosure can constitute a part of the onboard apparatus of the present disclosure and can achieve the same effects as the onboard apparatus of the present disclosure.

### First Embodiment

The first embodiment of the present disclosure will be described below with reference to the drawings.

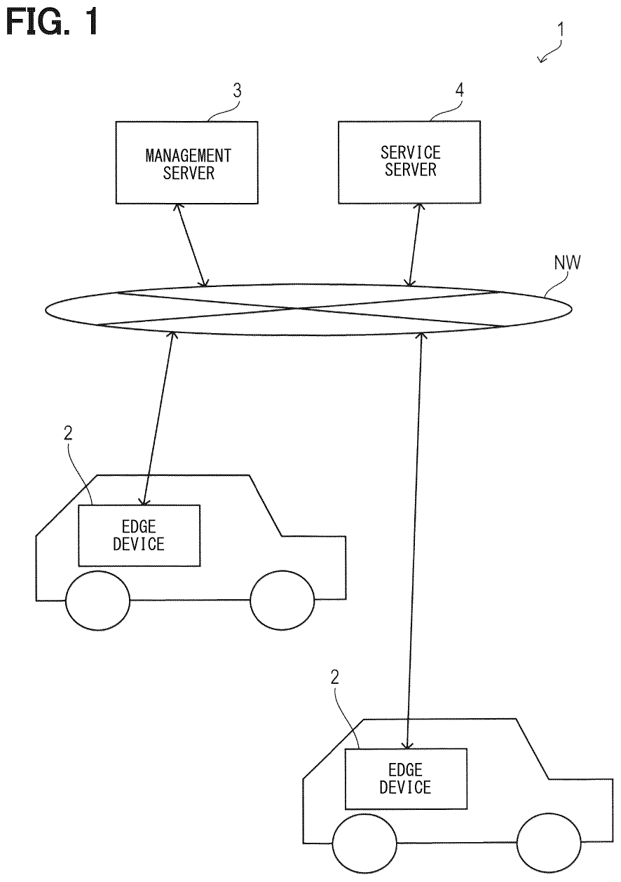

As shown in FIG. 1, the mobility IoT system 1 of this embodiment includes a plurality of edge devices 2, a management server 3, and a service server 4. IoT stands for Internet of Things. The management server 3 and the service server 4 may be configured as cloud servers.

The edge device 2 is mounted on a vehicle. Hereinafter, a vehicle equipped with the edge device 2 is referred to as an edge-equipped vehicle. The edge device 2 collects vehicle data from the edge-equipped vehicle and uploads the collected vehicle data to the management server 3. The edge device 2 executes vehicle control according to instructions from the management server 3. The edge device 2 executes various applications that are optionally installed.

The management server 3 performs data communication with the edge device 2 and the service server 4 via a wide-area communication network NW. The management server 3 stores the vehicle data uploaded from the edge device 2 in a database. The management server 3 provides the service server 4 with database of the management server 3 and an interface to access the edge-equipped vehicle.

The service server 4 utilizes the interface provided by the management server 3 to execute vehicle data collection and vehicle control for the edge-equipped vehicles, thereby providing various services to an occupant of the edge-equipped vehicle.

In this embodiment, the service server 4 is provided separately from the management server 3, but it may be provided integrally with the management server 3. The mobility IoT system 1 may include a plurality of service servers 4 that provide different services.

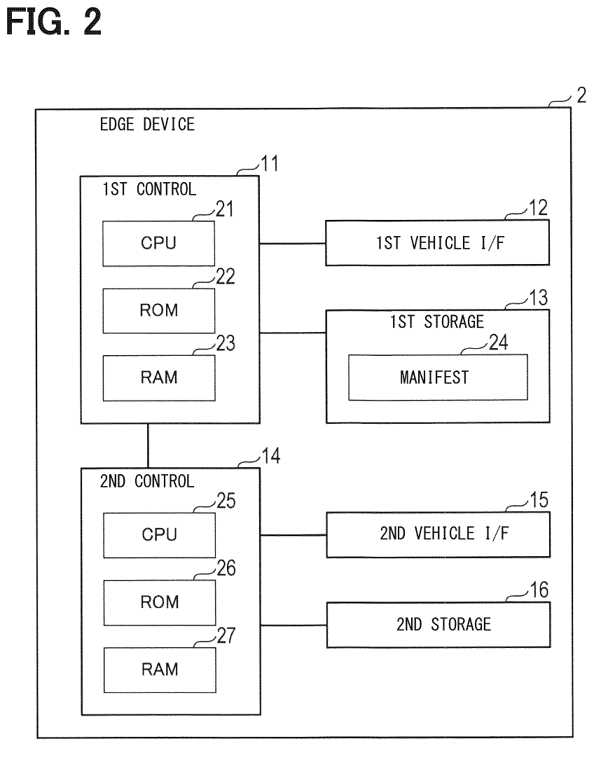

As shown in FIG. 2, the edge device 2 includes a first control unit 11, a first vehicle interface 12 (hereinafter, a first vehicle I/F 12), a first storage unit 13, a second control unit 14, a second vehicle interface 15 (hereinafter, a second vehicle I/F 15), and a second storage unit 16.

The first control unit 11 includes a CPU 21, a ROM 22, and a RAM 23. Various functions of the first control unit 11 are realized by the CPU 21 executing a program stored in a non-transitory tangible recording medium. In this example, the ROM 22 corresponds to the non-transitory tangible recording medium storing the program. By executing this program, the method corresponding to the program is executed. Some or all of the functions executed by the CPU 21 may be hardware-configured using one or more ICs or the like.

The first vehicle I/F 12 is an input/output circuit for inputting and outputting signals to and from onboard equipment and sensors or the like mounted on the edge-equipped vehicle. The first vehicle I/F 12 is connected to the first control unit 11.

The first storage unit 13 is a storage device for storing various data. The first storage unit 13 is connected to the first control unit 11. The manifest 24, which will be described later, is stored in the first storage unit 13.

The second control unit 14 includes a CPU 25, a ROM 26, and a RAM 27. Various functions of the second control unit 14 are realized by the CPU 25 executing a program stored in a non-transitory tangible recording medium. In this example, the ROM 26 corresponds to the non-transitory tangible recording medium storing the program. By executing this program, the method corresponding to the program is executed. Some or all of the functions executed by the CPU 25 may be hardware-configured using one or more ICs or the like. The second control unit 14 is connected to the first control unit 11 to enable data communication between them.

The second vehicle I/F 15 is an input/output circuit for inputting and outputting signals to and from onboard equipment and sensors or the like mounted on the edge-equipped vehicle. The second vehicle I/F 15 is connected to the second control unit 14.

The second storage unit 16 is a storage device for storing various data. The second storage unit 16 is connected to the second control unit 14.

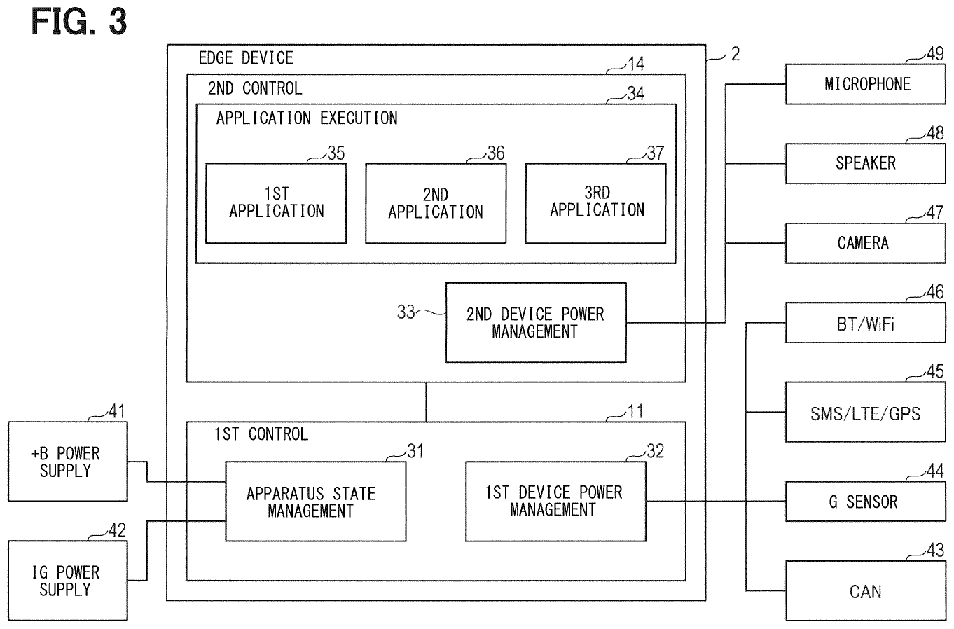

As shown in FIG. 3, the first control unit 11 of the edge device 2 includes an apparatus state management unit 31 and a first device power management unit 32 as functional blocks, which are realized by the CPU 21 executing the program stored in the ROM 22.

The apparatus state management unit 31 monitors the +B power supply 41 and the ignition power supply 42 (hereinafter, IG power supply 42) mounted on the edge-equipped vehicle and manages the state of the edge device 2 based on the power supply status from the +B power supply 41 and the IG power supply 42 to the edge device 2. The +B power supply 41 and the IG power supply 42 corresponds to an onboard power supply.

The first device power management unit 32 manages the power state of the devices connected to the first control unit 11 via the first vehicle I/F 12.

In this embodiment, the devices connected to the first control unit 11 include an onboard communication device 43, an acceleration sensor 44, an external communication device 45, and a short-range communication device 46.

The onboard communication device 43 is connected to various onboard equipment via the vehicle network of the edge-equipped vehicle and performs data communication with the onboard equipment. The vehicle network in this embodiment is a CAN (Controller Area Network). CAN is a registered trademark.

The acceleration sensor 44 detects the acceleration of the edge-equipped vehicle.

The external communication device 45 performs wide-area wireless communication in accordance with the LTE standard. The external communication device 45 receives SMS messages via wide-area wireless communication. The external communication device 45 receives radio waves transmitted from GPS satellites via a GPS antenna (not shown). LTE is a communication standard for mobile devices and stands for Long Term Evolution, SMS stands for Short Message Service, and GPS stands for Global Positioning System.

The short-range communication device 46 performs short-range wireless communication in accordance with the Bluetooth standard and performs short-range wireless communication in accordance with the Wi-Fi standard. Bluetooth and Wi-Fi are registered trademarks.

The second control unit 14 of the edge device 2 includes a second device power management unit 33 and an application execution unit 34 as functional blocks, which are realized by the CPU 25 executing the program stored in the ROM 26.

In this embodiment, the devices connected to the second control unit 14 include a camera 47, a speaker 48, and a microphone 49.

The camera 47 is mounted, for example, on the front side, rear side, and inside the cabin of the edge-equipped vehicle, and continuously captures the front and rear conditions of the edge-equipped vehicle and the conditions inside the cabin.

The speaker 48 is installed inside the cabin of the edge-equipped vehicle and outputs the sound indicated by the audio data input from the edge device 2.

The microphone 49 is installed inside the cabin of the edge-equipped vehicle and inputs the voice spoken by the occupant of the vehicle, outputting audio data indicating the input voice.

The first application 35, the second application 36, and the third application 37 are installed in the second control unit 14. The first, second, and third applications 35, 36, 37 provide different services to the vehicle users. The first, second, and third applications 35, 36, 37 may be pre-installed in the edge device 2 or optionally installed later. Pre-installed applications (i.e., pre-installed apps) in the edge device 2 may be configured to become operational by enabling billing or the like through user selection.

Since the services provided by the first, second, and third applications 35, 36, 37 to the vehicle users are different, the devices used by each application are also different.

The application execution unit 34 executes the first, second, and third applications 35, 36, 37.

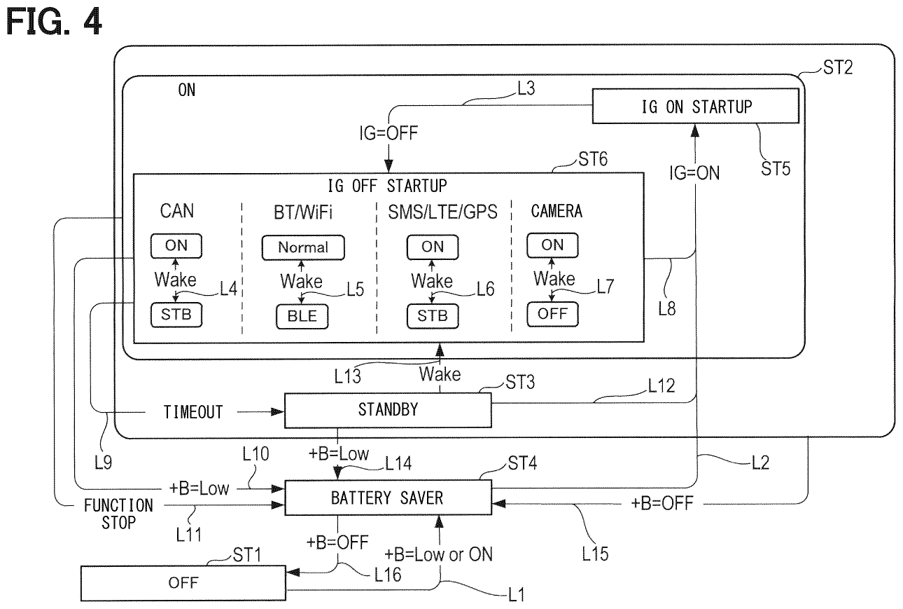

As shown in FIG. 4, the edge device 2 has the following power states: apparatus off state ST1, apparatus on state ST2, apparatus standby state ST3, and battery saver state ST4.

The off state is a state where power supply is cut off. The on state is a state where power is supplied. The standby state is a state where power is supplied but power consumption is suppressed compared to the on state.

The apparatus off state ST1 is the off state of the edge device 2. In other words, the apparatus off state ST1 is the power state of the edge device 2 when the +B power supply 41 is removed from the edge-equipped vehicle. In the apparatus off state ST1, the first control unit 11 and the second control unit 14 are in the off state. In the apparatus off state ST1, all devices connected to the edge device 2 (i.e., the onboard communication device 43, the acceleration sensor 44, the external communication device 45, the short-range communication device 46, the camera 47, the speaker 48, and the microphone 49) are in the off state. Hereinafter, the off state of the devices is referred to as the device off state.

The apparatus on state ST2 is the on state of the edge device 2. The apparatus on state ST2 is a power state in which power is supplied to the devices according to the requirements of the installed and operating applications.

The apparatus on state ST2 includes the ignition on start state ST5 and the ignition off start state ST6.

The ignition on start state ST5 is the power state of the edge device 2 when the IG power supply 42 is in the on state (hereinafter, IG on). In the ignition on start state ST5, power is supplied to the devices necessary for the applications operating during IG on.

The ignition off start state ST6 is the power state of the edge device 2 when the IG power supply 42 is in the off state (hereinafter, IG off). In the ignition off start state ST6, to suppress battery consumption, power is supplied only to the devices necessary for the applications operating during IG off. The devices necessary for the applications operating during IG off are set in the manifest 24.

The manifest 24 sets, for each application, the required power state for operation, the factors that trigger the application (hereinafter, wake-up factors), and the device usage information indicating the devices necessary for the application. For example, for the first application 35, the required power states are the ignition on start state ST5 and the ignition off start state ST6, the wake-up factor is the detection of acceleration above a predetermined value by the acceleration sensor 44, and the necessary device is the camera 47. For the second application 36, the required power state is the ignition on start state ST5, the wake-up factor is the transition of the edge device 2 to the ignition on start state ST5, and the necessary devices are the onboard communication device 43 and the external communication device 45. For the third application 37, the required power state is the ignition on start state ST5, the wake-up factor is the reception of an SMS message by the edge device 2, and the necessary devices are the short-range communication device 46, the speaker 48, and the microphone 49.

The manifest 24 may be created by the application developer and prepared for each application. When the edge device 2 obtains an application from an external source such as an app store and installs it in the application execution unit 34, the manifest 24 may be obtained from the external source along with the application and stored in the first storage unit 13. When the edge device 2 uninstalls an application from the application execution unit 34, the manifest 24 for that application is deleted from the first storage unit 13. Thus, in the edge device 2, which can obtain and install any application selected by the vehicle user from an app store or the like in the application execution unit 34, the first storage unit 13 may store the manifest 24 obtained from the external source along with the application for each of the one or more applications installed in the application execution unit 34.

The applications executed by the application execution unit 34 may include pre-installed applications (i.e., pre-installed apps) in the application execution unit 34 of the edge device 2, in addition to or instead of the applications obtained and installed from an external source such as an app store. In this case, the first storage unit 13 stores the manifest 24 for the pre-installed applications in advance.

The apparatus standby state ST3 is the standby state of the edge device 2. The apparatus standby state ST3 is a power state with lower power consumption than the apparatus on state ST2, allowing only the minimum necessary operations to suppress power consumption.

In this embodiment, in the apparatus standby state ST3, the first control unit 11, the second control unit 14, the onboard communication device 43, the external communication device 45, and the short-range communication device 46 are in the standby state, the acceleration sensor 44 is in the on state, and the camera 47, the speaker 48, and the microphone 49 are in the off state.

The battery saver state ST4 is the power state of the edge device 2 when the +B power supply 41 is in a low battery state (i.e., the voltage of the +B power supply 41 is below a specified value). In the battery saver state ST4, the first control unit 11 is in the standby state, the second control unit 14 is in the off state, and all devices connected to the edge device 2 are in the off state. In this embodiment, the specified value is set to be higher than the voltage value at which the engine cannot be started. That is, the battery saver state ST4 in this embodiment is a state where the voltage is sufficient to start the engine. Note that the battery saver state ST4 is not limited to the state where the voltage of the +B power supply 41 is below the specified value, but may transition to the battery saver state ST4 when a predetermined condition indicating the need to suppress the power consumption of the +B power supply 41 is met.

When the edge device 2 is in the apparatus off state ST1 and the +B power supply 41 is attached to the edge-equipped vehicle or the +B power supply 41 becomes a low battery state, the edge device 2 transitions to the battery saver state ST4 as indicated by arrow L1.

When the edge device 2 is in the battery saver state ST4, and when the low battery state of the +B power supply 41 is resolved and the IG power supply 42 switches from IG off to IG on, the edge device 2 transitions to the ignition on start state ST5 as indicated by arrow L2. When the edge device 2 is in the battery saver state ST4 and the low battery state of the +B power supply 41 is resolved and the IG power supply 42 is IG off, the edge device 2 transitions to the apparatus standby state ST3.

When the edge device 2 is in the ignition on start state ST5 and the IG power supply 42 switches from IG on to IG off, the edge device 2 transitions to the ignition off start state ST6 as indicated by arrow L3.

When the edge device 2 is in the ignition off start state ST6 and a wake-up factor for an application using the onboard communication device 43 occurs, the onboard communication device 43 transitions from the standby state to the on state as indicated by arrow L4.

When the edge device 2 is in the ignition off start state ST6 and a wake-up factor for an application using the short-range communication device 46 occurs, the short-range communication device 46 transitions from the standby state to the on state as indicated by arrow L5. Note that the short-range communication device 46 in the standby state performs short-range wireless communication in accordance with the BLE standard. BLE is an extension of Bluetooth and stands for Bluetooth Low Energy.

When the edge device 2 is in the ignition off start state ST6 and a wake-up factor for an application using the external communication device 45 occurs, the external communication device 45 transitions from the standby state to the on state as indicated by arrow L6.

When the edge device 2 is in the ignition off start state ST6 and a wake-up factor for an application using the camera 47 occurs, the camera 47 transitions from the off state to the on state as indicated by arrow L7.

When the edge device 2 is in the ignition off start state ST6 and the IG power supply 42 switches from IG off to IG on, the edge device 2 transitions to the ignition on start state ST5 as indicated by arrow L8.

When the edge device 2 is in the ignition off start state ST6 and a specified time has elapsed since the application started processing, the edge device 2 transitions to the apparatus standby state ST3 as indicated by arrow L9.

When the edge device 2 is in the ignition off start state ST6 and the +B power supply 41 becomes a low battery state, the edge device 2 transitions to the battery saver state ST4 as indicated by arrow L10.

When the edge device 2 is in the apparatus on state ST2 and the functions of the edge device 2 stop, the edge device 2 transitions to the battery saver state ST4 as indicated by arrow L11.

When the edge device 2 is in the apparatus standby state ST3 and the IG power supply 42 switches from IG off to IG on, the edge device 2 transitions to the ignition on start state ST5 as indicated by arrow L12.

When the edge device 2 is in the apparatus standby state ST3 and any wake-up factor occurs, the edge device 2 transitions to the ignition off start state ST6 as indicated by arrow L13.

When the edge device 2 is in the apparatus standby state ST3 and the +B power supply 41 becomes a low battery state, the edge device 2 transitions to the battery saver state ST4 as indicated by arrow L14.

When the edge device 2 is in the apparatus on state ST2 or the apparatus standby state ST3 and the +B power supply 41 is removed from the edge-equipped vehicle, the edge device 2 transitions to the apparatus off state ST1 as indicated by arrows L15 and L16.

Next, the procedure of the IG on start processing executed by the CPU 21 of the first control unit 11 will be described. The IG on start processing is a process that starts when the edge device 2 transitions to the apparatus standby state ST3.

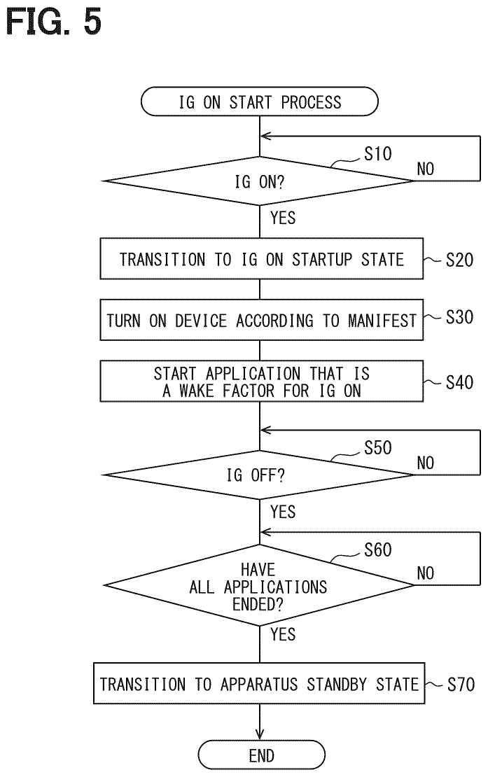

When the IG on start processing is executed, the CPU 21 first determines whether the IG power supply 42 has switched from IG off to IG on at step S10, as shown in FIG. 5. If the IG power supply 42 has not switched to IG on, the CPU 21 repeats the process of step S10, waiting until the IG power supply 42 switches to IG on.

When the IG power supply 42 switches from IG off to IG on, the CPU 21 transitions the edge device 2 to the ignition on start state ST5 at step S20. Specifically, the CPU 21 turns on the first control unit 11 and instructs the CPU 25 to turn on the second control unit 14.

At step S30, the CPU 21 turns on the devices used by the applications for which IG on is a wake-up factor according to the manifest 24. The CPU 21 turns on the devices connected to the first control unit 11 and instructs the CPU 25 to turn on the devices connected to the second control unit 14.

At step S40, the CPU 21 instructs the CPU 25 to start the applications for which IG on is a wake-up factor according to the manifest 24.

At step S50, the CPU 21 determines whether the IG power supply 42 has switched from IG on to IG off. If the IG power supply 42 has not switched to IG off, the CPU 21 repeats the process of step S50, waiting until the IG power supply 42 switches to IG off.

When the IG power supply 42 switches from IG on to IG off, the CPU 21 determines at step S60 whether all the applications started at step S40 have finished. If not all applications have finished, the CPU 21 repeats the process of step S60, waiting until all applications finish.

When all applications have finished, the CPU 21 transitions the edge device 2 to the apparatus standby state ST3 at step S70, thereby ending the IG on start processing.

Next, the procedure of the IG off start processing executed by the CPU 21 of the first control unit 11 will be described. The IG off start processing is a process that starts when the edge device 2 transitions to the apparatus standby state ST3.

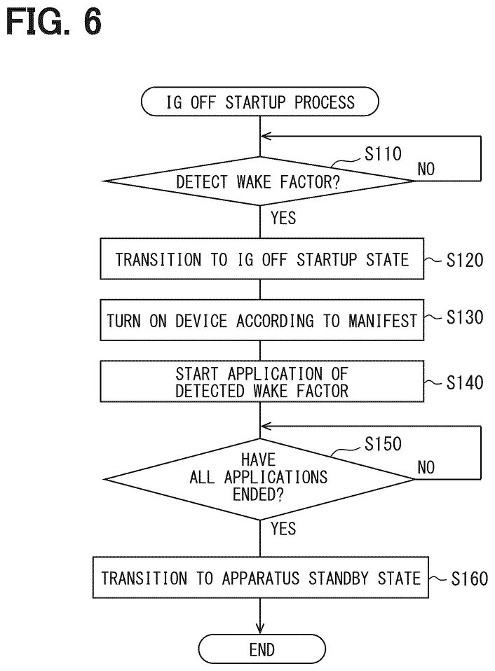

When the IG off start processing is executed, the CPU 21 first determines at step S110 whether a wake-up factor detected by a device has been detected, as shown in FIG. 6. If a wake-up factor detected by a device has not been detected, the CPU 21 repeats the process of step S110, waiting until a wake-up factor detected by a device is detected.

When a wake-up factor detected by a device is detected, the CPU 21 transitions the edge device 2 to the ignition off start state ST6 at step S120.

At step S130, the CPU 21 turns on the devices used by the applications that start with the wake-up factor detected at step S110 according to the manifest 24.

At step S140, the CPU 21 starts the applications set to start with the wake-up factor detected at step S110 according to the manifest 24.

At step S150, the CPU 21 determines whether all the applications started at step S140 have finished. If not all applications have finished, the CPU 21 repeats the process of step S150, waiting until all applications finish.

When all applications have finished, the CPU 21 transitions the edge device 2 to the apparatus standby state ST3 at step S160, thereby ending the IG off start processing.

Next, the procedure of the voltage monitoring processing executed by the CPU 21 of the first control unit 11 will be described. The voltage monitoring processing is a process that starts when the edge device 2 transitions to the apparatus on state ST2 or the apparatus standby state ST3.

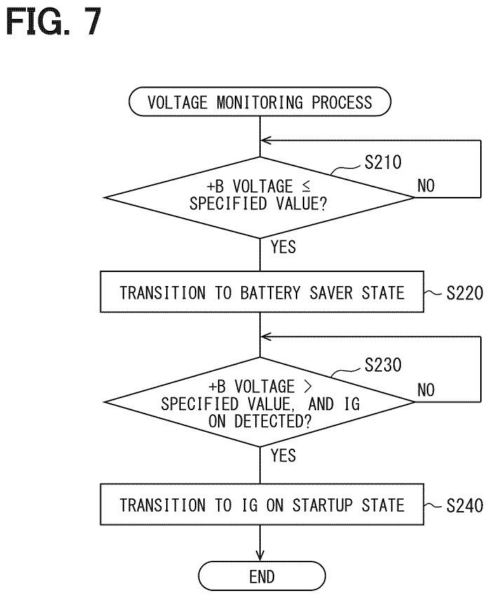

When the voltage monitoring processing is executed, the CPU 21 first determines at step S210 whether the voltage of the +B power supply 41 (hereinafter, +B voltage) is below a predetermined specified value indicating that the +B power supply 41 is in a low battery state, as shown in FIG. 7. If the +B voltage exceeds the specified value, the CPU 21 repeats the process of step S210, waiting until the +B voltage falls below the specified value.

When the +B voltage falls below the specified value, the CPU 21 transitions the edge device 2 to the battery saver state ST4 at step S220.

At step S230, the CPU 21 determines whether the +B voltage exceeds the specified value and whether IG on has been detected. If the +B voltage is below the specified value or IG on has not been detected, the CPU 21 repeats the process of step S230, waiting until the +B voltage exceeds the specified value and IG on is detected.

When the +B voltage exceeds the specified value and IG on is detected, the CPU 21 transitions the edge device 2 to the ignition on start state ST5 at step S240, in the same manner as step S20, thereby ending the voltage monitoring processing.

Next, the procedure of the wake-up factor monitoring processing executed by the CPU 21 of the first control unit 11 will be described. The wake-up factor monitoring processing is a process that starts when one application is activated due to a wake-up factor detected by a device.

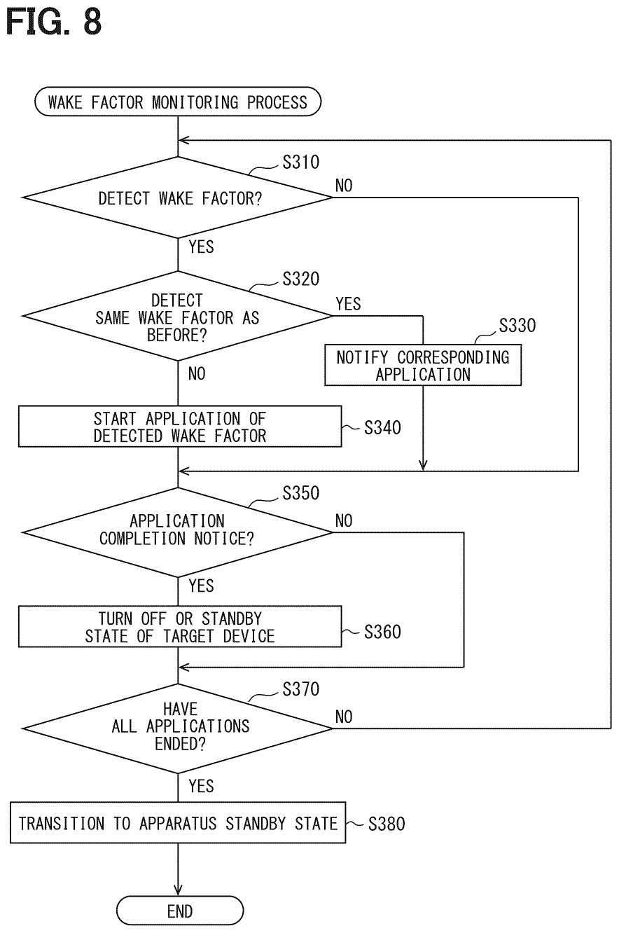

When the wake-up factor monitoring processing is executed, the CPU 21 first determines at step S310 whether a wake-up factor detected by a device has been detected, as shown in FIG. 8. If a wake-up factor detected by a device has not been detected, the CPU 21 proceeds to step S350. On the other hand, if a wake-up factor detected by a device has been detected, the CPU 21 determines at step S320 whether the wake-up factor detected at step S310 is the same as the previously detected wake-up factor. Specifically, the CPU 21 determines whether the wake-up factor that triggered the start of the wake-up factor monitoring processing is the same as the wake-up factor detected since the start of the current wake-up factor monitoring processing.

If the wake-up factor detected at step S310 is the same as the previously detected wake-up factor, the CPU 21 notifies the application corresponding to the wake-up factor detected at step S310 that the wake-up factor has been detected at step S330, and then proceeds to step S350. The application that receives this notification executes predetermined additional processing in response to the newly detected wake-up factor. This additional processing may include, for example, executing a predetermined process corresponding to the newly detected wake-up factor or delaying the termination of the application by a preset additional time corresponding to the newly detected wake-up factor.

On the other hand, if the wake-up factor detected at step S310 is not the same as the previously detected wake-up factor, the CPU 21 starts the application set to start with the wake-up factor detected at step S310 according to the manifest 24 at step S340, and then proceeds to step S350.

At step S350, the CPU 21 determines whether a completion notification has been received from the application. If a completion notification has not been received from the application, the CPU 21 proceeds to step S370. If a completion notification has been received from the application, the CPU 21 turns off or puts into standby state the devices used by the application corresponding to the completion notification according to the manifest 24 at step S360, and then proceeds to step S370. However, the CPU 21 excludes from this process the devices that detect the wake-up factors of the stopped application and the devices necessary for the operating application to execute processing. The CPU 21 instructs the CPU 25 to turn off or put into standby state the devices connected to the first control unit 11 and the devices connected to the second control unit 14.

At step S370, the CPU 21 determines whether all applications have finished. If not all applications have finished, the CPU 21 returns to step S310. If all applications have finished, the CPU 21 transitions the edge device 2 to the apparatus standby state ST3 at step S380, thereby ending the wake-up factor monitoring processing.

The edge device 2 configured as described above is mounted on a vehicle and includes the first and second vehicle I/Fs 12, 15, the apparatus state management unit 31, the application execution unit 34, the first and second device power management units 32, 33, and the manifest 24.

The first and second vehicle I/Fs 12, 15 are configured to connect to multiple onboard devices (i.e., the onboard communication device 43, the acceleration sensor 44, the external communication device 45, the short-range communication device 46, the camera 47, the speaker 48, and the microphone 49) mounted on the vehicle.

The apparatus state management unit 31 is configured to manage the apparatus power state of the edge device 2 based on the power supply status from the +B power supply 41 and the IG power supply 42 mounted on the vehicle.

The application execution unit 34 is configured to install the first, second, and third applications 35, 36, 37 and execute the installed first, second, and third applications 35, 36, 37.

The first and second device power management units 32, 33 are configured to manage the device power state of the onboard devices connected to the first and second vehicle I/Fs 12, 15.

The manifest 24 sets the device usage information indicating the onboard devices used by each of the first, second, and third applications 35, 36, 37.

The edge device 2 is configured to have the apparatus on state ST2, the apparatus standby state ST3, and the battery saver state ST4 as apparatus power states.

The apparatus state management unit 31 is configured to transition the edge device 2 to one of the apparatus power states, the apparatus on state ST2, the apparatus standby state ST3, or the battery saver state ST4, based on the power supply status.

The multiple onboard devices are configured to have, as the device power state, the device off state, which is the off state of the onboard devices, the device on state, which is the on state of the onboard devices, and the device standby state, which is the standby state of the onboard devices, or to have the device off state and the device on state without having the device standby state.

When the edge device 2 is in the apparatus on state ST2, the application execution unit 34 is in the on state. The first and second device power management units 32, 33 turn on the onboard devices necessary for the installed and operating applications to execute processing based on the device usage information in the manifest 24.

When the edge device 2 is in the apparatus standby state ST3, the application execution unit 34 is in the standby state. The first and second device power management units 32, 33 turn on or put into standby state at least the onboard devices that can detect wake-up factors.

When the edge device 2 is in the battery saver state ST4, the application execution unit 34 is in the off state.

The apparatus state management unit 31 transitions the edge device 2 from the apparatus on state ST2 or the apparatus standby state ST3 to the battery saver state ST4 when a predetermined battery saver transition condition indicating that the voltage value of the +B power supply 41 is low (in this embodiment, the +B voltage is below the specified value) is met.

Such an edge device 2 turns on the onboard devices necessary for the installed and operating applications to execute processing based on the device usage information in the manifest 24. Therefore, even if an onboard device is retrofitted to the edge device 2, the edge device 2 can suppress the occurrence of a situation where an onboard device not used by the operating application is unnecessarily turned on. This reduces the power consumption of the onboard devices.

In the edge device 2, the application execution unit 34 is in the standby state when the edge device 2 is in the apparatus standby state ST3, and the application execution unit 34 is in the off state when the edge device 2 is in the battery saver state ST4. Therefore, the edge device 2 can suppress the occurrence of a situation where the application execution unit 34 is unnecessarily turned on when the application is not operating. This reduces the power consumption of the edge device 2.

As described above, the edge device 2 can reduce the power consumption of both the edge device 2 and the onboard devices, thereby suppressing the voltage drop of the +B power supply 41 and the IG power supply 42.

When the edge device 2 is in the battery saver state ST4, the first and second device power management units 32, 33 turn off all the onboard devices connected to the edge device 2. The apparatus state management unit 31 transitions the edge device 2 from the battery saver state ST4 to the apparatus on state ST2 or the apparatus standby state ST3 when a predetermined battery saver release condition indicating that the voltage value of the +B power supply 41 is not low (in this embodiment, the +B voltage exceeds the specified value) is met. Such an edge device 2 turns off all the onboard devices when in the battery saver state ST4, further reducing the power consumption of the edge device 2 and the onboard devices.

When the onboard apparatus is in the ignition off start state ST6, the first and second device power management units 32, 33 turn on the onboard devices necessary for the installed and operating applications to execute processing based on the device usage information in the manifest 24. Such an edge device 2 can suppress the occurrence of a situation where onboard devices not used by the operating applications are unnecessarily turned on in the ignition off start state ST6, thereby further reducing the power consumption of the onboard devices.

When the edge device 2 is in the ignition on start state ST5, the first and second device power management units 32, 33 turn on the onboard devices necessary for the installed and operating applications to execute processing based on the device usage information in the manifest 24. Such an edge device 2 can suppress the occurrence of a situation where onboard devices not used by the operating applications are unnecessarily turned on in the ignition on start state ST5, thereby further reducing the power consumption of the onboard devices.

The manifest 24 sets the wake-up factors for each of the first, second, and third applications 35, 36, 37 in addition to the device usage information. When the edge device 2 is in the apparatus standby state ST3, the apparatus state management unit 31 transitions the edge device 2 to the apparatus on state ST2 when a wake-up factor set in the manifest 24 occurs. The second application 36 has the type of apparatus power state set as a wake-up factor. The first application 35 has the detection result by the acceleration sensor 44 set as a wake-up factor. Such an edge device 2 can hold the edge device 2 in the apparatus standby state ST3 until a wake-up factor occurs, thereby further reducing the power consumption of the edge device 2.

When the edge device 2 is in the ignition off start state ST6, the apparatus state management unit 31 transitions the edge device 2 to the apparatus standby state ST3 when the operating applications complete their operations. Such an edge device 2 can suppress the occurrence of a situation where the edge device 2 is unnecessarily held in the ignition off start state ST6 when the applications are not operating, thereby further reducing the power consumption of the edge device 2.

The apparatus state management unit 31 transitions the edge device 2 to the ignition on start state ST5 when the edge device 2 switches from IG off, where the power supply from the IG power supply 42 is cut off, to IG on, where the power supply from the IG power supply 42 is provided. When the edge device 2 switches from IG on to IG off, the apparatus state management unit 31 transitions the edge device 2 to the apparatus standby state ST3 when the operating applications complete their operations if there are any operating applications at the time of the switch to IG off. Such an edge device 2 can suppress the occurrence of a situation where the edge device 2 is unnecessarily held in the ignition off start state ST6 when the applications are not operating, thereby further reducing the power consumption of the edge device 2.

The application execution unit 34 is configured to operate the first, second, and third applications 35, 36, 37 simultaneously. When the first, second, and third applications 35, 36, 37 are operating simultaneously, the first and second device power management units 32, 33 turn on the onboard devices necessary for each of the first, second, and third applications 35, 36, 37 to execute processing. When at least one of the first, second, and third applications 35, 36, 37 completes its operation, the first and second device power management units 32, 33 turn off or put into standby state the unnecessary onboard devices (hereinafter, unnecessary devices). Unnecessary device is an onboard device among the multiple onboard devices connected to the edge device 2, excluding the onboard devices that detect the wake-up factors of the stopped applications and the onboard devices necessary for the operating applications to execute processing. Such an edge device 2 can suppress the occurrence of a situation where unnecessary devices are unnecessarily turned on, thereby further reducing the power consumption of the onboard devices.

When the edge device 2 is in the ignition off start state ST6, the apparatus state management unit 31 notifies the operating applications when a wake-up factor of the operating applications occurs. The applications that receive the notification execute predetermined additional processing in response to the reoccurrence of the wake-up factor. When the operating applications complete their operations, the apparatus state management unit 31 transitions the edge device 2 to the apparatus standby state ST3. Such an edge device 2 executes additional processing for the operating applications when the wake-up factor reoccurs. This allows the edge device 2 to avoid the need to terminate and restart the operating applications each time the wake-up factor reoccurs, thereby further reducing the power consumption of the edge device 2.

In the embodiment described above, the edge device 2 corresponds to the onboard apparatus, and the onboard communication device 43, the acceleration sensor 44, the external communication device 45, the short-range communication device 46, the camera 47, the speaker 48, and the microphone 49 correspond to the onboard devices.

The first and second vehicle I/Fs 12, 15 correspond to the device connection unit, the +B power supply 41 and the IG power supply 42 correspond to the onboard power supply, and the first, second, and third applications 35, 36, 37 correspond to the applications.

The first and second device power management units 32, 33 correspond to the device power management unit, the ignition on start state ST5 corresponds to the ignition on start state, and the ignition off start state ST6 corresponds to the ignition off start state.

### Second Embodiment

The second embodiment of the present disclosure will be described below with reference to the drawings. In the second embodiment, parts that differ from the first embodiment will be explained. Common configurations are denoted by the same reference numerals.

The mobility IoT system 1 of the second embodiment differs from the first embodiment in that the wake-up factor monitoring processing has been modified.

The wake-up factor monitoring processing of the second embodiment differs from the first embodiment in that it executes the processes of steps S410 to S440 instead of steps S350 to S380.

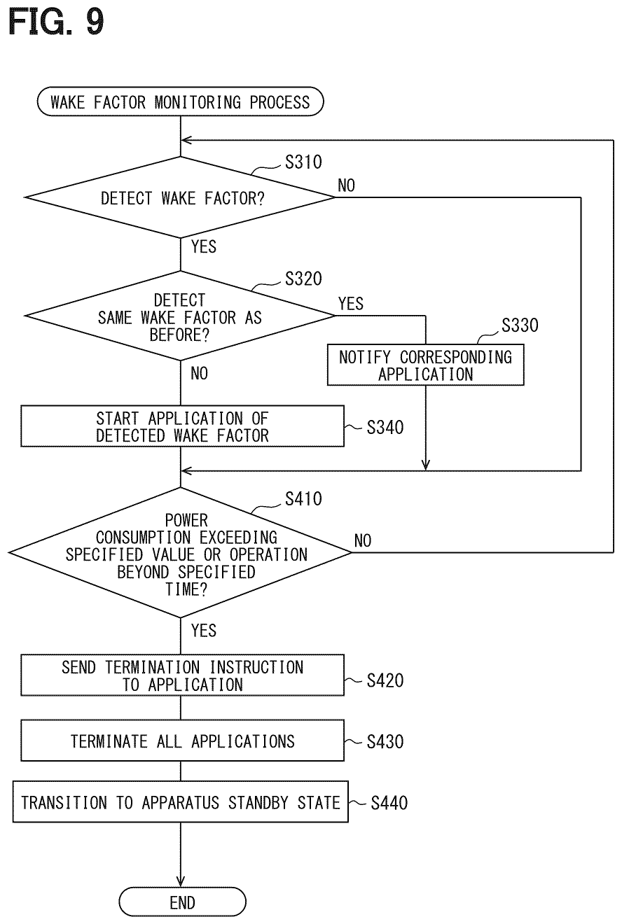

That is, as shown in FIG. 9, if a wake-up factor is not detected at step S310, the CPU 21 proceeds to step S410. When the processing of step S330 is completed, the CPU 21 proceeds to step S410. When the processing of step S340 is completed, the CPU 21 proceeds to step S410.

At step S410, the CPU 21 determines whether the power consumption due to the operation of the application since the start of the wake-up factor monitoring processing is equal to or greater than a predetermined specified power value and whether the operation time of the application since the start of the wake-up factor monitoring processing is equal to or greater than a specified time.

If the power consumption due to the operation of the application is less than the specified power value and the operation time of the application is less than the specified time, the CPU 21 returns to step S310.

On the other hand, if the power consumption due to the operation of the application is equal to or greater than the specified power value or the operation time of the application is equal to or greater than the specified time, the CPU 21 notifies the operating application to terminate at step S420.

At step S430, the CPU 21 terminates all operating applications.

At step S440, the CPU 21 transitions the edge device 2 to the apparatus standby state ST3, thereby ending the wake-up factor monitoring processing.

In the edge device 2 configured as described above, when the edge device 2 is in the ignition off start state, the apparatus state management unit 31 forcibly stops one or more operating applications and notifies the one or more operating applications of the forced stop when at least one of a predetermined first stop condition and a predetermined second stop condition is met. The first stop condition is a condition indicating that the power consumption of one or more operating applications is high. In this embodiment, the first stop condition is that the power consumption due to the operation of the application since the start of the wake-up factor monitoring processing is equal to or greater than a predetermined specified power value. The second stop condition is a condition indicating that the operation time of one or more operating applications is long. In this embodiment, the second stop condition is that the operation time of the application since the start of the wake-up factor monitoring processing is equal to or greater than a specified time.

Such an edge device 2 can suppress the increase in power consumption of the applications and the extension of the operation time of the applications in the ignition off start state, thereby further reducing the power consumption of the edge device 2 and the onboard devices.

Although an embodiment of the present disclosure has been described above, the present disclosure is not limited to the above embodiment and can be implemented in various modified forms.

### Modification Example 1

In the above embodiment, when the edge device 2 is in the apparatus standby state ST3, the first and second device power management units 32, 33 turn on or put into standby state the onboard devices that can detect wake-up factors. However, the onboard devices that can detect wake-up factors may be determined based on the manifest 24 or predetermined without reference to the manifest 24. Additionally, for some of the onboard devices, the onboard devices that can detect wake-up factors may be determined based on the manifest 24, while for the remaining onboard devices, the onboard devices that can detect wake-up factors may be determined without reference to the manifest 24.

### Modification Example 2

In the above embodiment, when the edge device 2 is in the ignition on start state ST5, the onboard devices necessary for the installed and operating applications to execute processing are turned on based on the device usage information in the manifest 24. However, when the edge device 2 is in the ignition on start state ST5, all the onboard devices connected to the edge device 2 may be turned on. In this case, the edge device 2 may instruct the onboard devices to turn on, or the onboard devices may detect the ignition on start state ST5 and turn on.

The first and second control units 11, 14 and their methods described in the present disclosure may be implemented by a dedicated computer provided by configuring a processor and memory programmed to execute one or more functions embodied by a computer program. Alternatively, the first and second control units 11, 14 and their methods described in the present disclosure may be implemented by a dedicated computer provided by configuring a processor with one or more dedicated hardware logic circuits. The first and second control units 11, 14 and their methods described in the present disclosure may be implemented by one or more dedicated computers configured by a combination of a processor and memory programmed to execute one or more functions and one or more hardware logic circuits. The computer program may be stored as instructions executable by a computer on a computer-readable non-transitory tangible recording medium. The method for realizing the functions of each part included in the first and second control units 11, 14 does not necessarily have to include software, and all the functions may be realized using one or more hardware.

The multiple functions possessed by one component in the above embodiment may be realized by multiple components, or one function possessed by one component may be realized by multiple components. Additionally, the multiple functions possessed by multiple components may be realized by one component, or one function realized by multiple components may be realized by one component. Furthermore, part of the configuration of the above embodiment may be omitted. Additionally, at least part of the configuration of the above embodiment may be added to or replaced with the configuration of another embodiment.

In addition to the edge device 2 described above, the present disclosure can also be realized in various forms such as a system including the edge device 2 as a component, a program for making a computer function as the edge device 2, a non-transitory tangible recording medium such as a semiconductor memory recording the program, and a management method.

What is claimed is:

1. An onboard apparatus mounted on a vehicle, comprising:
a device connection unit configured to connect a plurality of onboard devices mounted on the vehicle;
an apparatus state management unit configured to manage an apparatus power state of the onboard apparatus;
an application execution unit configured to install a plurality of applications and execute the applications installed; and
a device power management unit configured to manage a device power state of the onboard devices connected to the device connection unit,
wherein:
an on state is defined as a state in which power is supplied;
a standby state is defined as a state in which the power is supplied and power consumption is suppressed compared to the on state;
the device power management unit sets at least the onboard device capable of detecting a wake-up factor, which is a factor for activating the application, to the on state or the standby state; and
the device power management unit sets, based on device usage information in a manifest in which the device usage information indicating the onboard device used by an installed application is set, an onboard device necessary for an installed and operating application to execute processing to a device on state, which is the on state of the onboard device.

2. The onboard apparatus according to claim 1, wherein:
an off state is defined as a state in which power supply is cut off;
the onboard apparatus is configured to have, as the apparatus power state, an apparatus on state, which is the on state of the onboard apparatus, and an apparatus standby state, which is the standby state of the onboard apparatus;
the plurality of onboard devices are configured to have, as the device power state, a device off state, which is the off state of the onboard device, a device on state, which is the on state of the onboard device, and a device standby state, which is the standby state of the onboard device, or are configured to have the device off state and the device on state without having the device standby state;
the device power management unit sets, when the onboard apparatus is in the apparatus on state, the onboard device necessary for the installed and operating application to execute processing to the device on state based on the device usage information in the manifest; and
the device power management unit sets, when the onboard apparatus is in the apparatus standby state, sets at least the onboard device capable of detecting a wake-up factor, which is a factor for activating the application, to the device on state or the device standby state.

3. The onboard apparatus according to claim 2, wherein:
the application execution unit is in the on state when the onboard apparatus is in the apparatus on state; and
the application execution unit is in the standby state when the onboard apparatus is in the apparatus standby state.

4. The onboard apparatus according to claim 2, wherein:
the onboard apparatus is further configured to have a battery saver state as the apparatus power state;
the application execution unit is in the off state when the onboard apparatus is in the battery saver state;
the apparatus state management unit is configured to manage the apparatus power state of the onboard apparatus based on the state of power supply from at least one onboard power supply mounted on the vehicle to the onboard apparatus; and
the apparatus state management unit transitions the onboard apparatus from the apparatus on state or the apparatus standby state to the battery saver state when a predetermined battery saver transition condition indicating that a voltage value of the at least one onboard power supply is low is met.

5. The onboard apparatus according to claim 1, wherein:
the plurality of onboard devices include at least one of an onboard communication device, an acceleration sensor, an external communication device, a short-range communication device, a camera, a speaker, and a microphone.

6. The onboard apparatus according to claim 4, wherein:
the device power management unit sets all the onboard device connected to the onboard apparatus to the device off state when the onboard apparatus is in the battery saver state.

7. The onboard apparatus according to claim 4, wherein:
the apparatus state management unit transitions the onboard apparatus from the battery saver state to the apparatus on state or the apparatus standby state when a predetermined battery saver release condition indicating that the voltage value of the at least one onboard power supply is not low is met.

8. The onboard apparatus according to claim 2, wherein:
the apparatus on state includes
an ignition on start state in which power is supplied by an ignition power supply, and
an ignition off start state in which power supply by the ignition power supply is cut off; and
the device power management unit sets, when the onboard apparatus is in the ignition off start state, the onboard device necessary for the installed and operating application to execute processing to the device on state based on the device usage information in the manifest.

9. The onboard apparatus according to claim 8, wherein:
the device power management unit sets, when the onboard apparatus is in the ignition on start state, the onboard device necessary for the installed and operating application to execute processing to the device on state based on the device usage information in the manifest.

10. The onboard apparatus according to claim 8, wherein:
the device power management unit sets, when the onboard apparatus is in the ignition on start state, all the onboard device connected to the onboard apparatus to the device on state.

11. The onboard apparatus according to claim 2, wherein:
the manifest includes the wake-up factor set for each of the plurality of applications in addition to the device usage information; and
the apparatus state management unit transitions the onboard apparatus to the apparatus on state when the onboard apparatus is in the apparatus standby state and when the wake-up factor set in the manifest occurs.

12. The onboard apparatus according to claim 2, wherein:
the plurality of applications includes an application for which a type of apparatus power state is set as the wake-up factor.

13. The onboard apparatus according to claim 2, wherein:
the plurality of applications includes an application for which a detection result by the onboard device is set as the wake-up factor.

14. The onboard apparatus according to claim 8, wherein:
the apparatus state management unit transitions the onboard apparatus to the apparatus standby state when the onboard apparatus is in the ignition off start state and when the application in operation completes the operation.

15. The onboard apparatus according to claim 8, wherein:
an ignition (IG) off state is defined as a condition in which the power supply by the ignition power supply is cut off;
an IG on state is defined as a condition in which the power is supplied by the ignition power supply;
the apparatus state management unit transitions the onboard apparatus to the ignition on start state when the onboard apparatus switches from the IG off state to the IG on state; and
the apparatus state management unit transitions the onboard apparatus to the apparatus standby state after the application in operation completes the operation when the onboard apparatus switches from the IG on state to the IG off state and when an application is operating at a timing when the IG off state is reached.

16. The onboard apparatus according to claim 2, wherein:
the application execution unit is configured to operate the plurality of applications simultaneously;
the device power management unit sets the onboard device necessary for each of the plurality of applications to execute processing to the device on state when the plurality of applications are operating simultaneously; and
the device power management unit sets an unnecessary device, which is the onboard device that is no longer needed, to the device off state or the device standby state when at least one of the applications in operation completes the operation.

17. The onboard apparatus according to claim 16, wherein:
the manifest includes the wake-up factor set for each of the plurality of applications in addition to the device usage information; and
the unnecessary device is an onboard device among the onboard devices connected to the onboard apparatus, excluding the onboard device that detects the wake-up factor of the application that have stopped operating, and the onboard device necessary for the application in operation to execute processing.

18. The onboard apparatus according to claim 8, wherein:
a predetermined first stop condition indicates that the power consumption of at least one application in operation is high;
a predetermined second stop condition indicates that an operation time of at least one operating application is long; and
when the onboard device is in the ignition off start state, the apparatus state management unit forcibly stops the application in operation when at least one of the first stop condition and the second stop condition is met, and further notifies the application in operation of a forced stop.

19. The onboard apparatus according to claim 8, wherein:
when the onboard apparatus is in the ignition off start state and when the wake-up factor of the application in operation occurs, the apparatus state management unit notifies the application in operation of occurrence of the wake-up factor;
the application that receives a notification of the occurrence of the wake-up factor executes a predetermined additional processing corresponding to reoccurrence of the wake-up factor; and
the apparatus state management unit transitions the onboard apparatus to the apparatus standby state when the application in operation completes the operation.

20. The onboard apparatus according to claim 1, wherein:
the application execution unit is capable of installing the plurality of applications obtained from outside the vehicle; and
the onboard apparatus further comprises
a storage unit that stores the manifest for each application installed in the application execution unit, the manifest being obtained from outside the vehicle along with the application.

21. An onboard system comprising:
a plurality of onboard devices;
an application execution unit configured to install a plurality of applications and execute the applications installed; and
a device power management unit configured to manage a device power state of the onboard devices,
wherein:
a standby state is defined as a state in which the power is supplied and power consumption is suppressed compared to an on state;
the device power management unit sets at least the onboard device capable of detecting a wake-up factor, which is a factor for activating the application, to the on state or the standby state; and
the device power management unit sets, based on device usage information in a manifest in which the device usage information indicating the onboard device used by an installed application is set, the onboard device necessary for the installed and operating application to execute processing to a device on state in which power is supplied.

22. A method executed by an onboard system including: a plurality of onboard devices; and an onboard apparatus configured to install a plurality of applications and execute the applications installed, the method comprising
managing a device power state of the onboard devices,
wherein:
a standby state is defined as a state in which the power is supplied and power consumption is suppressed compared to an on state;
managing the device power state of the onboard device sets at least the onboard device capable of detecting a wake-up factor, which is a factor for activating the application, to the on state or the standby state; and
managing the device power state of the onboard device includes setting the onboard device necessary for the installed and operating application to execute processing to a device on state based on device usage information in a manifest in which the device usage information indicating the onboard device used by an installed application is set.

23. A non-transitory computer readable storage medium storing a program for an onboard apparatus configured to connect a plurality of onboard devices mounted on a vehicle, install a plurality of applications, and execute the application installed, the program causing the onboard apparatus to execute processing comprising:
managing a device power state of the onboard device,
wherein:
a standby state is defined as a state in which the power is supplied and power consumption is suppressed compared to an on state;
managing the device power state of the onboard device sets at least the onboard device capable of detecting a wake-up factor, which is a factor for activating the application, to the on state or the standby state; and
managing the device power state of the onboard device includes setting the onboard device necessary for the installed and operating application to execute processing to a device on state based on device usage information in a manifest in which the device usage information indicating the onboard device used by an installed application is set.
